(19) United States
(12) Patent Application Publication
(10) Pub. No.: US 2024/0303064 A1
(43) Pub. Date: Sep. 12, 2024

(54) SOFTWARE UPDATE SYSTEM

(71) Applicant: TOYOTA JIDOSHA KABUSHIKI KAISHA, Toyota-shi (JP)

(72) Inventor: Fumiya Sato, Toyota-shi (JP)

(73) Assignee: TOYOTA JIDOSHA KABUSHIKI KAISHA, Toyota-shi (JP)

(21) Appl. No.: 18/400,145

(22) Filed: Dec. 29, 2023

(30) Foreign Application Priority Data
Mar. 7, 2023 (JP) 2023-034711

(51) Int. Cl. G06F 8/65

(52) U.S. Cl. CPC G06F 8/65

(57) ABSTRACT

The software update system performs software update processing for the on-board ECU. The software update system includes a server that stores divided packages in which update data is divided into multiple pieces in association with package IDs, an on-board ECU that can execute update processing, a server that sends update information received from the on-board ECU to the server, and an update device capable of transmitting divided packages received from the on-board ECU. The on-board ECU generates and stores update information including the package ID of the received divided package and the update device ID of the update device that is communicatively connected. Based on the update information, the server extracts the divided packages that have not been received by the on-board ECU and transmits them to the on-board ECU.

### CROSS-REFERENCE TO RELATED APPLICATION

This application claims priority to Japanese Patent Application No. 2023-034711 filed on Mar. 7, 2023, incorporated herein by reference in its entirety.

### BACKGROUND

### 1. Technical Field

The present disclosure relates to a software update system that performs a software update process for an on-board electronic control unit (ECU).

### 2. Description of Related Art

Vehicles include on-board ECUs that perform various control processes. In such an on-board ECU, a software update process for the on-board ECU is performed to correct or change processing details. For example, Japanese Unexamined Patent Application Publication No. 2017-97620 (JP 2017-97620 A) describes an on-board device that acquires software update data from a server outside a vehicle by using a communication terminal and performs a software update process based on the acquired update data.

### SUMMARY

There are various update devices such as an update device that transmits update data to an on-board ECU by using wireless communication, and an update device that transmits update data to an on-board ECU by using wired communication. In recent years, the amount of update data has been increasing, and it may take time to transmit the update data to the on-board ECU. For this reason, it is conceivable to switch the update device while transmitting update data to the on-board ECU. However, such switching is not taken into consideration in the configuration described in JP 2017-97620 A.

Therefore, the present disclosure describes a software update system that can continue to appropriately transmit update data to an on-board ECU even when an update device that transmits the update data to the on-board ECU is switched.

One aspect of the present disclosure relates to a software update system configured to perform a process for updating software of an on-board electronic control unit. The software update system includes:
a server configured to store divided packages obtained by dividing update data for the software into a plurality of pieces in association with package identifiers of the divided packages;
the on-board electronic control unit configured to perform the process for updating the software; and
a plurality of update devices each configured to be communicatively connected to the on-board electronic control unit and transmit the divided package received from the server to the on-board electronic control unit while being communicatively connected to the on-board electronic control unit.

The on-board electronic control unit includes:
an update information storage unit configured to generate and store update information including the package identifier of the received divided package and an update device identifier of the update device that is communicatively connected;
an update information transmission unit configured to transmit the update information to the update device that is communicatively connected;
a package reception unit configured to receive the divided package from the update device that is communicatively connected; and
an update processing unit configured to perform the process for updating the software based on the received divided package.

The update device includes:
a first transmission unit configured to transmit the update information received from the on-board electronic control unit to the server while being communicatively connected to the on-board electronic control unit; and
a second transmission unit configured to transmit the divided package received from the server to the on-board electronic control unit while being communicatively connected to the on-board electronic control unit.

The server includes:
a storage unit configured to store the divided packages and the package identifiers in association with each other;
an update information reception unit configured to receive the update information transmitted from the update device;
an extraction unit configured to extract the divided package that has not been received by the on-board electronic control unit from the divided packages stored in the storage unit based on the package identifier of the received divided package included in the received update information; and
a package transmission unit configured to transmit the extracted divided package to the update device associated with the update device identifier included in the received update information.

In the above software update system,
the package transmission unit may be configured to:
when a communication method between the on-board electronic control unit and the update device identified by the update device identifier is wired communication, determine priority levels to first transmit the divided package with a larger data amount among the divided packages to be transmitted; and
when the communication method between the on-board electronic control unit and the update device identified by the update device identifier is wireless communication, determine the priority levels to first transmit the divided package with a smaller data amount among the divided packages to be transmitted.

According to the one aspect of the present disclosure, it is possible to continue to appropriately transmit the update data to the on-board ECU even when the update device that transmits the update data to the on-board ECU is switched.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing the overall configuration of a software update system according to an embodiment; and

FIG. 2 is a sequence diagram showing the flow of update processing performed in the software update system.

### DETAILED DESCRIPTION OF EMBODIMENTS

Hereinafter, exemplary embodiments will be described with reference to the drawings. In each figure, the same or corresponding elements are designated by the same reference signs, and duplicated description will be omitted.

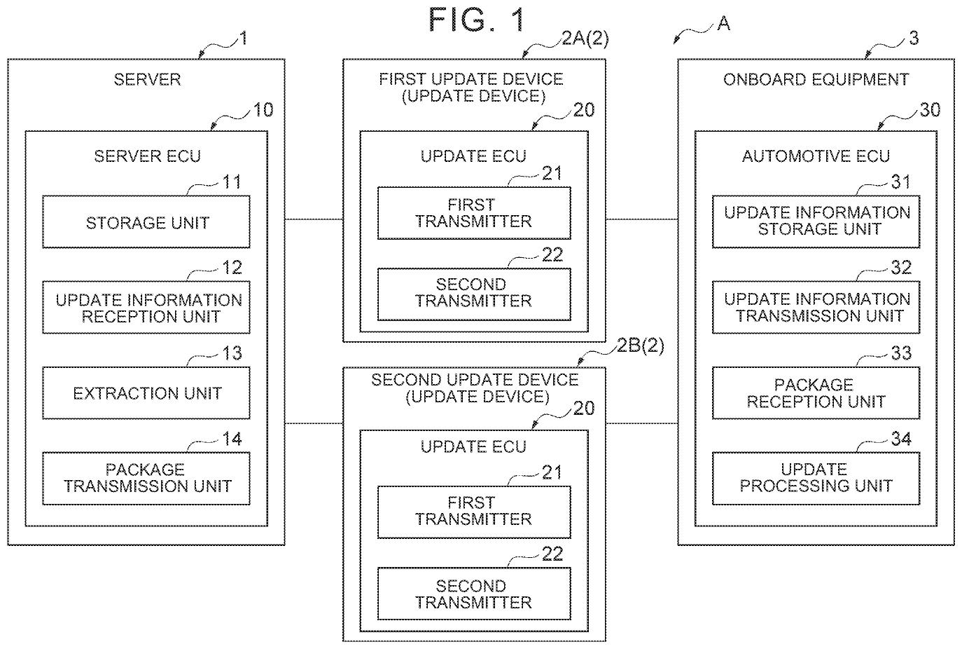

As shown in FIG. 1, the software update system A performs a software update process for the on-board ECU 30. The on-board ECU 30 is included in the on-vehicle device 3 mounted on the vehicle. The on-vehicle device 3 is not particularly limited as long as the on-board ECU 30 is provided. The software update system A includes a server 1, a plurality of update devices 2, and an on-board ECU 30. FIG. 1 shows, as an example, a case where two update devices are provided. Further, when distinguishing the plurality of update devices 2 from each other, they may be referred to as a first update device 2A and a second update device 2B.

First, an overview of the entire software update system A will be explained. The server 1 stores a software update program for operating the on-board ECU 30. Here, the server 1 stores divided packages obtained by dividing update data into a plurality of pieces in association with the package ID of the divided packages.

The update device 2 is a device used to update the software of the on-board ECU 30. The update device 2 can be communicatively connected to the on-board ECU 30 by various methods. The update device 2 can transmit update data (divided packages) received from the server 1 to the on-board ECU while being communicatively connected to the on-board ECU 30.

For example, the update device 2 can communicate with the on-vehicle device 3 (on-board ECU 30) through wired communication or wireless communication. This wired communication may be performed, for example, by connecting a cable dedicated to communication between the update device 2 and the on-vehicle device 3 (on-board ECU 30). Moreover, when the vehicle in which the on-vehicle device 3 is mounted is a battery electric vehicle (BEV), this wired communication may be performed via a cable for power supply to the vehicle. That is, the power supply equipment to the vehicle may also serve as the update device 2.

This wireless communication may be performed based on various communication standards such as Wi-Fi communication and Bluetooth (registered trademark) communication. This wireless communication between the update device 2 and the on-vehicle device 3 may be performed while the vehicle in which the on-vehicle device 3 is mounted is running. Note that communication is performed between the update device 2 and the server 1 using various methods such as wired communication.

The on-board ECU 30 of the on-vehicle device 3 receives divided packages obtained by dividing update data from the server 1 via the update device 2. The on-board ECU 30 can execute a software update process for operating itself based on the received divided package.

Here, for example, the amount of update data used to update the on-board ECU 30 may be large. In such a case, it is conceivable to switch the update device 2 during the update process. For example, while updating the on-vehicle device 3 using the first update device 2A that performs wireless communication, it may be possible to switch to the second update device 2B that performs wired communication and perform the update process.

Switching of the update device 2 used in this update process is performed, for example, by a user of a vehicle in which the on-vehicle device 3 is mounted, a worker who performs maintenance work on the vehicle, or the like. Hereinafter, details of a configuration that can take over and execute the software update process of the on-board ECU 30 even when the update device 2 is switched will be described.

The on-board ECU 30 is an electronic control unit that includes a Central Processing Unit (CPU), Read Only Memory (ROM), Random Access Memory (RAM), and the like. The on-board ECU 30 realizes various functions by, for example, loading a program recorded in a ROM into a RAM, and executing the program loaded into the RAM by a CPU. The on-board ECU 30 may include an active memory that stores a program being executed and a non-active memory that stores a program that is being updated. Functionally, the on-board ECU 30 includes an update information storage unit 31, an update information transmission unit 32, a package reception unit 33, and an update processing unit 34.

The update information storage unit 31 generates update information including the package ID of the received divided package received from the server 1 via the update device 2 and the update device ID of the update device 2 that is communicatively connected. The update information storage unit 31 stores the generated update information. The update device 2 in the communication-connected state is the update device 2 that can communicate with the on-vehicle device 3 through wired communication or wireless communication, as described above. Every time the update information storage unit 31 receives a divided package, the update information storage unit 31 updates the package ID of the received divided package included in the update information. Further, each time the update device 2 connected for communication is switched, the update information storage unit 31 updates the update device ID included in the update information.

The update information may further include various information related to software updates, such as version information (update version information) of software for operating the on-board ECU 30 and status information indicating the update status.

The update information transmission unit 32 transmits the update information stored in the update information storage unit 31 to the update device 2 that is communicatively connected. Here, the update information transmission unit 32 may transmit update information in response to a request from the update device 2 that is communicatively connected. In other words, when the update device 2 is connected to the on-vehicle device 3 in order to update the software of the on-board ECU 30, the update information transmission unit 32 may transmit update information in response to a request from the update device 2. Further, each time the update information is updated by the update information storage unit 31, the update information transmission unit 32 may transmit new update information to the update device 2.

The package reception unit 33 receives the divided package from the update device 2 that is communicatively connected. In this way, the package reception unit 33 can receive the divided packages stored in the server 1 via the update device 2 that is communicatively connected.

The update processing unit 34 performs software update processing based on the divided packages received by the package reception unit 33. For example, the update processing unit 34 can perform the software update process by writing the received divided package to a non-active memory that stores the program being updated.

When updating the software of the on-board ECU 30 of the on-vehicle device 3, the update device 2 is communicatively connected to the on-vehicle device 3 (on-board ECU 30). This communication connection is made, for example, by a user of a vehicle in which the on-vehicle device 3 is mounted, a worker who performs maintenance work on the vehicle, or the like. For example, when the update device 2 and the on-vehicle device 3 are communicably connected by wireless communication, the update device 2 and the on-vehicle device 3 may be communicably connected by a user or the like operating the on-vehicle device 3. For example, when the update device 2 and the on-vehicle device 3 are connected through wired communication, the update device 2 and the on-vehicle device 3 may be connected by a user etc. by connecting the communication cable provided in the update device 2 to the on-vehicle device 3.

The update device 2 includes an update ECU 20. In addition to the update ECU 20, the update device 2 includes communication equipment and the like for communicating with the server 1 and the on-vehicle device 3, respectively. The update ECU 20 is an electronic control unit having a similar configuration to the on-board ECU 30. The update ECU 20 functionally includes a first transmission unit 21 and a second transmission unit 22.

The first transmission unit 21 receives update information transmitted from the update information transmission unit 32 of the on-board ECU 30 while being communicatively connected to the on-vehicle device 3 (on-board ECU 30). The first transmission unit 21 then transmits the received update information to the server 1. Note that the first transmission unit 21 may request the update information transmission unit 32 of the on-vehicle device 3 to transmit the update information.

The second transmission unit 22 transmits the divided package received from the server 1 to the on-vehicle device 3 (on-board ECU 30) while being communicatively connected to the on-vehicle device 3 (on-board ECU 30). Note that after the second transmission unit 22 receives all of the plurality of divided packages transmitted from the server 1, the second transmission unit 22 may sequentially transmit the divided packages to the on-vehicle device 3. Furthermore, each time the second transmission unit 22 receives each of the plurality of divided packages transmitted from the server 1, the second transmission unit 22 may sequentially transmit the received divided packages to the on-vehicle device 3.

The server 1 stores update data for updating software of the on-board ECU 30. The server 1 transmits divided packages obtained by dividing the update data to the on-vehicle device 3 via any one of the plurality of update devices 2. Specifically, the server 1 includes a server ECU 10. The server ECU 10 is an electronic control unit having the same configuration as the no-board ECU 30. Functionally, the server ECU 10 includes a storage unit 11, an update information reception unit 12, an extraction unit 13, and a package transmission unit 14.

The storage unit 11 stores divided packages obtained by dividing update data into a plurality of pieces in association with the package ID of the divided packages. The storage unit 11 may store update version information of update data, etc., as well as these divided packages. The update information reception unit 12 receives update information transmitted from the first transmission unit 21 of the update device 2.

The extraction unit 13 extracts the divided packages that have not been received by the on-vehicle device 3 (on-board ECU 30) from among the divided packages stored in the storage unit 11, based on the package ID of the received divided packages included in the received update information. For example, the extraction unit 13 can also extract divided packages of update data of appropriate versions based on update version information included in the update information.

The package transmission unit 14 identifies the update device 2 corresponding to the update device ID included in the update information received by the update information reception unit 12. The package transmission unit 14 transmits the divided package extracted by the extraction unit 13 to the specified update device 2. The identified update device 2 is the update device 2 that is communicatively connected to the on-vehicle device 3 in order to perform software update processing. In this way, the package transmission unit 14 can identify the update device 2 to which the divided package is to be sent, based on the update device ID included in the update information.

Next, the flow of software update processing for the on-board ECU 30 performed in the software update system A will be described. Here, an example will be described in which the update device 2 used for the update process is switched to the second update device 2B during the update process using the first update device 2A.

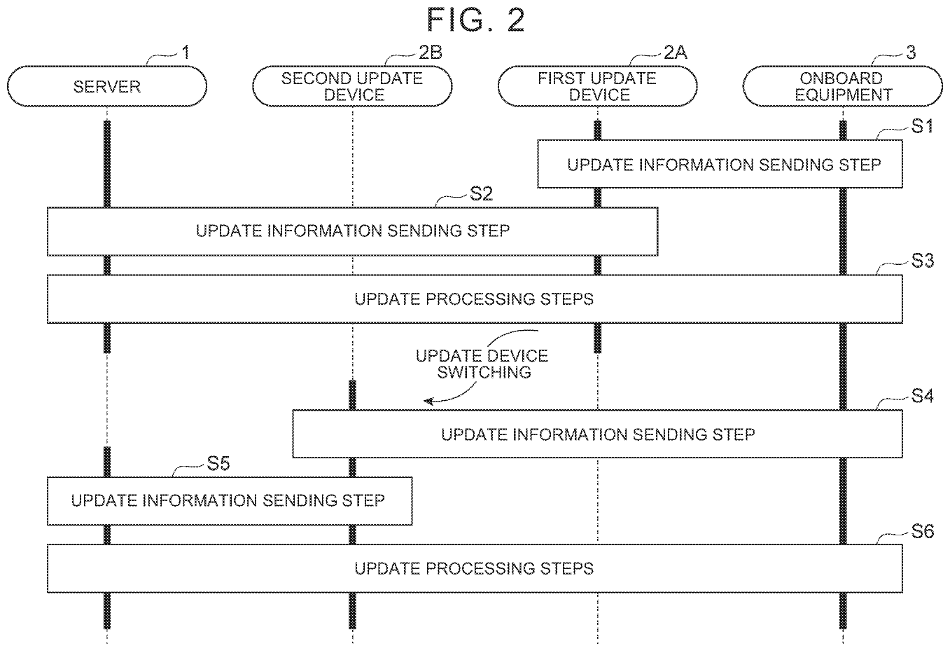

As shown in FIG. 2, when the first update device 2A is communicatively connected to the on-vehicle device 3, the update information transmission unit 32 of the on-board ECU 30 installed in the on-vehicle device 3 sends the update information to the first update device 2A (update information transmission S1). Here, the update information transmission unit 32 can transmit update information to the first update device 2A in response to a request to send update information from the first update device 2A. The first transmission unit 21 of the first update device 2A transmits the update information received from the on-vehicle device 3 to the server 1 (update information transmission S2).

The extraction unit 13 of the server 1 receives update information transmitted from the first update device 2A. Thereby, the server 1 can recognize the update device 2 (here, the first update device 2A) connected to the on-vehicle device 3 and the divided package that the on-vehicle device 3 has received, based on the update information. Then, the server 1, the first update device 2A, and the on-vehicle device 3 perform a software update process in update process S3.

Here, the extraction unit 13 of the server 1 extracts the divided packages that the on-vehicle device 3 has not received. The package transmission unit 14 of the server 1 transmits the extracted divided packages to the first update device 2A. The second transmission unit 22 of the first update device 2A receives the divided package transmitted from the server 1, and transmits the received divided package to the on-vehicle device 3. The package reception unit 33 of the on-vehicle device 3 receives the divided package transmitted from the first update device 2A. The update processing unit 34 of the on-vehicle device 3 performs software update processing based on the received divided package.

Here, a more detailed example of the software update process in the update process S3 will be described. Note that the specific examples of the update process described below are just examples, and the update process is not limited to these specific examples.

### First Example of Update Processing

First, a first example of update processing will be described. In this first example, each time the reception of a divided package is completed in the on-vehicle device 3, the divided packages are transmitted one by one from the server 1 to the on-vehicle device 3 via the first update device 2A. Specifically, the package transmission unit 14 of the server 1 transmits one of the plurality of divided packages extracted by the extraction unit 13 to the first update device 2A. The second transmission unit 22 of the first update device 2A transmits the divided package received from the server 1 to the on-vehicle device 3.

The update processing unit 34 of the on-vehicle device 3 performs an update process based on the divided package transmitted from the first update device 2A. When the update process based on the received divided package is completed, the update information storage unit 31 of the on-vehicle device 3 updates the package ID of the received divided package included in the update information.

When the update information is updated, the update information transmission unit 32 of the on-vehicle device 3 transmits the updated update information to the first update device 2A. The first transmission unit 21 of the first update device 2A transmits the update information received from the on-vehicle device 3 to the server 1. The extraction unit 13 of the server 1 extracts unreceived divided packages based on the received update information. Thereafter, the update process is performed by repeating the process flow described above.

In this first example, the package transmission unit 14 of the server 1 determines priority levels for transmission among the extracted plurality of divided packages based on the communication method between the first update device 2A and the on-vehicle device 3 (on-board ECU 30). Then, the package transmission unit 14 may transmit the divided packages to the first update device 2A based on the determined priority order. The package transmission unit 14 can identify the communication method between the first update device 2A and the on-vehicle device 3, for example, based on the update device ID included in the received update information.

More specifically, for example, when the communication method between the first update device 2A and the on-vehicle device 3 is wired communication, the package transmission unit 14 can determine the priority levels to first transmit a divided package with a large amount of data among a plurality of divided packages to be transmitted. Further, for example, when the communication method between the first update device 2A and the on-vehicle device 3 is wireless communication, the package transmission unit 14 can determine the priority levels to first transmit a divided package with a smaller amount of data among a plurality of divided packages to be transmitted.

Depending on the communication method between the first update device 2A and the on-vehicle device 3, the stability of communication, communication speed, etc. may differ. Therefore, the package transmission unit 14 can first transmit divided packages suitable for transmission and reception using the current communication method by determining the priority order of transmission of divided packages based on the communication method. For example, wireless communication may have lower communication stability or slower communication speed than wired communication. For this reason, it is possible that the package transmission unit 14 determines the priority order based on whether the communication method is wired communication or wireless communication, takes into consideration the characteristics of the communication method, and transmits divided packages suitable for transmission and reception using the current communication method.

### Second Example of Update Processing

Next, a second example of update processing will be described. In this second example, all (or a plurality of) divided packages that have not been received by the on-vehicle device 3 are transmitted to the first update device 2A. The first update device 2A stores a plurality of transmitted divided packages, and each time the on-vehicle device 3 completes reception of a divided package, the first update device 2A is an example in which one divided package is transmitted to the on-vehicle device 3. Specifically, the package transmission unit 14 of the server 1 transmits all (or a plurality) of the plurality of divided packages extracted by the extraction unit 13 to the first update device 2A.

The first update device 2A stores a plurality of divided packages sent from the server 1. The second transmission unit 22 of the first update device 2A transmits one of the stored divided packages to the on-vehicle device 3. The update processing unit 34 of the on-vehicle device 3 performs an update process based on the divided package transmitted from the first update device 2A. When the update process based on the received divided package is completed, the update information storage unit 31 of the on-vehicle device 3 updates the package ID of the received divided package included in the update information.

When the update information is updated, the update information transmission unit 32 of the on-vehicle device 3 transmits the updated update information to the first update device 2A. The second transmission unit 22 of the first update device 2A transmits to the on-vehicle device 3 the divided packages that the on-vehicle device 3 has not received, among the stored divided packages, based on the update information received from the on-vehicle device 3. Thereafter, the update process is performed by repeating the process flow described above.

In addition, in this second example, the second transmission unit 22 of the first update device 2A determines priority levels for transmitting multiple divided packages transmitted from the server 1 based on the communication method between the first update device 2A and the on-vehicle device 3 (on-board ECU 30). The second transmission unit 22 may then transmit the divided packages to the on-vehicle device 3 based on the determined priority order. The communication method between the first update device 2A and the on-vehicle device 3 is determined in advance.

More specifically, for example, when the communication method between the first update device 2A and the on-vehicle device 3 is wired communication, the second transmission unit 22 of the first update device 2A selects one of the plurality of stored divided packages. Priority can be determined so that divided packages with a large amount of data are sent first. Further, for example, when the communication method between the first update device 2A and the on-vehicle device 3 is wireless communication, the second transmission unit 22 of the first update device 2A selects the amount of data among the plurality of stored divided packages. Priority can be determined so that fewer divided packages are sent first.

Depending on the communication method between the first update device 2A and the on-vehicle device 3, the stability of communication, communication speed, etc. may differ. Therefore, the second transmission unit 22 can first transmit divided packages suitable for transmission and reception using the current communication method by determining the priority order of transmission of divided packages based on the communication method. For example, wireless communication may have lower communication stability or slower communication speed than wired communication. For this reason, the second transmission unit 22 determines the priority order based on whether the communication method is wired communication or wireless communication, thereby considering the characteristics of the communication method and making it possible to first transmit suitable for the current communication method.

Here, assume that the update device 2 is switched from the first update device 2A to the second update device 2B during the update process S3 shown in FIG. 2. When the update device 2 is switched to the second update device 2B, the update process using the first update device 2A ends.

When the second update device 2B is communicatively connected to the on-vehicle device 3, the update information transmission unit 32 of the on-board ECU 30 mounted on the on-vehicle device 3 transmits update information to the second update device 2B (update information transmission S4). Here, the update information transmission unit 32 can transmit update information to the second update device 2B in response to a request to send update information from the second update device 2B. Upon receiving the transmission information from the on-vehicle device 3, the first transmission unit 21 of the second update device 2B transmits the received update information to the server 1 (update information transmission S5).

The extraction unit 13 of the server 1 receives the update information transmitted from the second update device 2B. Thereby, the server 1 can recognize the update device 2 (here, the second update device 2B) connected to the on-vehicle device 3 and the divided package that the on-vehicle device 3 has received, based on the update information. Then, the server 1, the second update device 2B, and the on-vehicle device 3 perform a software update process in the update process S6, similar to the update process S3 described above.

As described above, the server 1 divides and stores update data for performing software update processing into a plurality of pieces. Based on the update information transmitted from the on-vehicle device 3, the server 1 can recognize the divided packages that have been received by the update device 2 and the on-vehicle device 3 that are in communication connection with the on-vehicle device 3. Then, the server 1 can transmit the unreceived divided packages to the on-vehicle device 3 via the update device 2 which is communicatively connected to the on-vehicle device 3.

Furthermore, the update device 2 may be switched. Even in this case, based on the update information transmitted from the on-vehicle device 3, the server 1 can recognize the update device 2 that has newly entered a communication connection state with the on-vehicle device 3, and divided packages that have been received by the on-vehicle device 3. Then, the server 1 can transmit the divided package that has not been received to the on-vehicle device 3 via the update device 2 that is newly connected for communication.

In other words, the software update system A is not configured to perform update processing by transmitting the entire update data from the beginning even when the update device 2 is switched. In the software update system A, even if the update device 2 is switched, the update data is taken over and transmitted from the middle. In this way, the software update system A can continue to appropriately transmit update data to the on-board ECU even when the update device that transmits the update data to the on-board ECU is switched. Therefore, in the software update system A, even if the update device 2 is switched, the software update process of the on-board ECU 30 is taken over from the middle, and the update process can be continued.

Furthermore, the update process in the on-board ECU 30 may fail due to, for example, a communication error, a write error, a process timeout, or the like. Even in this case, the software update system A can continue the update process from the point where the update process has failed.

What is claimed is:

1. A software update system configured to perform a process for updating software of an on-board electronic control unit, the software update system comprising:
a server configured to store divided packages obtained by dividing update data for the software into a plurality of pieces in association with package identifiers of the divided packages;
the on-board electronic control unit configured to perform the process for updating the software; and
a plurality of update devices each configured to be communicatively connected to the on-board electronic control unit and transmit the divided package received from the server to the on-board electronic control unit while being communicatively connected to the on-board electronic control unit, wherein
the on-board electronic control unit includes:
an update information storage unit configured to generate and store update information including the package identifier of the received divided package and an update device identifier of the update device that is communicatively connected;
an update information transmission unit configured to transmit the update information to the update device that is communicatively connected;
a package reception unit configured to receive the divided package from the update device that is communicatively connected; and
an update processing unit configured to perform the process for updating the software based on the received divided package,
the update device includes:
a first transmission unit configured to transmit the update information received from the on-board electronic control unit to the server while being communicatively connected to the on-board electronic control unit; and
a second transmission unit configured to transmit the divided package received from the server to the on-board electronic control unit while being communicatively connected to the on-board electronic control unit, and
the server includes:
a storage unit configured to store the divided packages and the package identifiers in association with each other;
an update information reception unit configured to receive the update information transmitted from the update device;
an extraction unit configured to extract the divided package that has not been received by the on-board electronic control unit from the divided packages stored in the storage unit based on the package identifier of the received divided package included in the received update information; and
a package transmission unit configured to transmit the extracted divided package to the update device associated with the update device identifier included in the received update information.

2. The software update system according to claim 1, wherein the update information storage unit is configured to update the update information each time reception of the divided package is completed.

3. The software update system according to claim 1, wherein the package transmission unit is configured to determine priority levels of transmission of a plurality of the extracted divided packages based on a communication method between the on-board electronic control unit and the update device identified by the update device identifier included in the received update information, and transmit the divided packages based on the determined priority levels.

4. The software update system according to claim 3, wherein the package transmission unit is configured to:
when the communication method between the on-board electronic control unit and the update device identified by the update device identifier is wired communication, determine the priority levels to first transmit the divided package with a larger data amount among the divided packages to be transmitted; and
when the communication method between the on-board electronic control unit and the update device identified by the update device identifier is wireless communication, determine the priority levels to first transmit the divided package with a smaller data amount among the divided packages to be transmitted.
